(19) United States
(12) Patent Application Publication
(10) Pub. No.: US 2005/0234815 A1
(43) Pub. Date: Oct. 20, 2005

(54) Methods and systems for optimization of economic value from asset sets

(76) Inventor: Peter Martin, Carver, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/091,075

(22) Filed: Mar. 28, 2005

Related U.S. Application Data
(60) Provisional application No. 60/557,129, filed on Mar. 26, 2004.

(51) Int. Cl. G06F 17/60

(52) U.S. Cl. 705/39

(57) ABSTRACT

Methods and systems for optimizing economic value from a assets are disclosed. Operations, including use and maintenance, are performed on the assets, where operations are determined from settings. The desired settings are those that result in the assets producing optimal economic value. To determine desirable settings, dynamic performance measures of economic performance data are prioritized. A process is then performed, starting with the highest-priority measure. The process includes collecting operational performance data as operations are performed and calculating economic performance data therefrom. The process also includes determining the desired settings for each measure by identifying the optimal value for the measure over a period of time and identifying the set of settings that produced the optimal value. The process is repeated for each successive measure, with sets of settings that do not result in substantial change in the value of any higher-priority measure from its identified optimal value.

### CROSS-REFERENCE TO RELATED APPLICATION

The present application claims the benefit of U.S. Provisional Patent Application Ser. No. 60/557,129, which was filed on Mar. 26, 2004, by Peter Martin for A Mechanism For The Economic Optimization Of Process Manufacturing Operations and is hereby incorporated by reference.

### BACKGROUND OF THE INVENTION

1. Field of the Invention

The disclosed methods and systems relate generally to optimization, and more particularly to the optimization of the economic value of asset sets.

2. Background Information

Traditionally, there has been no effective way to economically optimize the performance of the asset set or sets contained within a process manufacturing plant or major plant area, so that maximum economic value is achieved from each of the assets in the set. The common approach to this problem has been to start at the lowest lever component assets in the plant, optimize each component asset with-respect to either asset utilization or asset availability, then use system, circuit or network approaches to combine the component assets into higher level asset combinations. The shortcomings of this approach have been three-fold.

First, the asset utilization and asset availability functions of manufacturing assets tend to have inverse functional characteristics as each approaches its optimum point, as shown in FIG. 1. Thus, optimizing either the availability function or the utilization function will tend to sub-optimize the other, and will also tend to sub-optimize the economic value generated from the asset. For example, operating most plants at full output will almost always lead to a higher level of wear and tear on the plant equipment, which will certainly lower asset availability over time. Conversely, maximizing the availability may typically only be accomplished by shutting the plant down. Obviously, neither of these is the desired approach to plant operations if optimizing the economic value generated over time by the assets in the plant is the ultimate objective.

Second, effective economic modeling to the component level has been very difficult to accomplish because of the inherent complexity of process manufacturing plants. These plants are comprised of many vessels and pieces of equipment interconnected by piping and interlaced with pumps, valves and measuring instruments, among other components. Attempting to develop an overall plant asset model for either asset utilization analysis or asset availability analysis is often too tedious and complicated to be effective. These models also tend to be variable with plant conditions and states, further limiting any potential effectiveness. In trying to determine how to best model the economic value generated from an industrial plant asset base, the most common approach has been to decompose the asset base to the base component level, as shown in FIG. 2, and then try to model the component asset value. Most often this was done from either an asset availability or asset utilization perspective. Improving utilization of the component asset base has typically been addressed through process control techniques. More advanced control approaches have been developed to effectively manage the utilization of sets of component assets. But even with the advancements made in control science, seldom are these approaches able to address complex components combinations even to the process unit level. This has severely limited the availability of such metrics.

Third, combining the component asset models into models for larger asset sets, such as process units and even sub units, is extremely complex. The science in asset availability and maintenance has lagged behind that of process control, making it even less sophisticated than what has been accomplished in the area of asset utilization. The science in both the areas of asset utilization optimization and asset availability optimization has advanced significantly in the past decade. But, neither has approached the point at which plant level optimization is practical through this bottom-up approach due to the inherent complexities and dynamics in process manufacturing.

Traditionally in process manufacturing operations, the financial data associated with the operation of the plant has been provided by monthly financial reporting for both the plant and the corporate financial functions. Therefore, the data used in the financial systems has been limited to monthly totals, typically for the overall plant operations. Since the plant operations staff runs the plant in real-time, with changes occurring second by second, the traditional financial data stored in the plant financial system has been of little or no value, as it is only updated from month-to-month. As a result, optimization activities within process plants have been based, typically, on operational data contextualized into economic value by engineering based on presumed financial relationships. Finance personnel tend to place very little credibility into such key performance indicators.

Further, activity done at a shorter time period that one month and at a subplant level has been almost impossible to measure in terms of financial data. Since industrial plants operate in real-time, with many activities occurring daily in the typical plant, the impact of a specific activity on economic value has been difficult to discern from the finance system. Thus, there is a need to determine how economic value is affected by changes in operations in real-time.

### SUMMARY OF THE INVENTION

In an embodiment of the invention, there is provided a method of determining, for a set of assets on which operations are performed, settings for the operations that result in the assets producing optimal economic value. The operations include use of the assets and maintenance performed on the assets, and the settings and operations change over time. The method includes prioritizing dynamic performance measures, where dynamic performance measures comprise economic performance data. The method further includes performing, during a time period, a process. The process includes:
collecting and storing as operations are performed on the assets, operational performance data about the assets and the settings that produced the data;
calculating and storing, in real-time, economic performance data from the collected operational data; and
determining, for the highest-priority dynamic performance measure, those settings that will result in optimal economic value from the assets for that measure, by identifying the optimal value for the measure over a period of time and identifying the set of settings that produced the optimal value during that period of time.
   The method also includes determining, for each of a plurality of successive dynamic performance measures in order of decreasing priority, the settings that will result in optimal economic value from the assets for each measure, by repeating the above process with sets of settings that do not result in a substantial change in the value of any higher-priority measure from its identified optimal value.

In a related embodiment, the method may also include setting initial settings for the operations, where the initial settings are the settings determined according to the process, and the process has been repeated for the plurality of successive measures; displaying at least one of the dynamic performance measures in real-time; and determining if changes made to the initial settings result in further optimal economic value being derived from the assets, by:
changing at least one of the initial settings;
viewing the displayed measure over time to learn if the at least one changed setting has positively impact the measure; and
if there is a positive impact on the measure, maintaining the at least one changed setting, and if not, returning the at least one changed setting to its initial setting.

In a further related embodiment, the method may also include repeating the process for the highest-priority dynamic performance measure and the plurality of successive measures to determine further settings; comparing the further settings to the current settings to determine any differences between the current settings and the further settings; and changing the current settings to the further settings if there are differences.

In another related embodiment, storing may occur in a process historian. In a further related embodiment, the process historian may be part of a process control system, and collecting and calculating may occur within the process control system.

In another embodiment, there is provided a computer system configured to determine, for a set of assets on which operations are performed, settings for the operations that result in the assets producing optimal economic value, where operations include use of the assets and maintenance performed on the assets, and the settings and operations change over time. The computer system is configured to prioritize dynamic performance measures, where dynamic performance measures comprise economic performance data, and perform, during a time period, a process. That process includes:
collecting and storing, as operations are performed on the assets, operational performance data about the assets and the settings that produced the data;
calculating and storing, in real-time, economic performance data from the collected operational data; and
determining, for the highest-priority dynamic performance measure, those settings that will result in optimal economic value from the assets for that measure, by identifying the optimal value for the measure over a period of time and identifying the set of settings that produced the optimal value during that period of time.
   The computer system is also configured to determine, for each of a plurality of successive dynamic performance measures in order of decreasing priority, the settings that will result in optimal economic value from the assets for each measure, by repeating the above process with sets of settings that do not result in a substantial change in the value of any higher-priority measure from its identified optimal value.

In a related embodiment, the computer system may be further configured to set initial settings for the operations, where the initial settings are the settings determined according to the process, and the process has been repeated for the plurality of successive measures; display at least one of the dynamic performance measures in real-time; and determine if changes made to the initial settings result in further optimal economic value being derived from the assets, by:
changing at least one of the initial settings; viewing the displayed measure over time to learn if the at least one changed setting has positively impact the measure; and
if there is a positive impact on the measure, maintaining the at least one changed setting, and if not, returning the at least one changed setting to its initial setting.

In yet a further related embodiment, the computer system may be further configured to repeat the process for the highest-priority dynamic performance measure and the plurality of successive measures to determine further settings; compare the further settings to the current settings to determine any differences between the current settings and the further settings; and change the current settings to the further settings if there are differences.

In another related embodiment, the computer system may be a process control system.

In another embodiment of the invention, there is provided a method of calculating economic value generated from the operations performed on a set of assets over a period of time as those operations change. Operational performance data is collected and stored in real-time, the operational performance data is about the assets in the set as operations are performed on the assets. The method also includes calculating and storing, in real-time, economic performance data from the collected operational performance data, where the economic performance data comprise dynamic performance measures; determining a baseline value for each dynamic performance measure over the period of time; and determining, for each measure, the difference between the current value of the measure and the baseline value of the measure.

In a related embodiment, storing may occur in a process historian. In a further related embodiment, the process historian may determine the baseline value for each dynamic performance measure over the period of time. In still a further related embodiment, the process historian may be part of a process control system, and collecting, calculating, and determining the difference all may occur within the process control system.

### BRIEF DESCRIPTION OF THE DRAWINGS

The invention description below refers to the accompanying drawings, of which:

FIG. 1 is a graph of an asset availability function versus an asset utilization function;

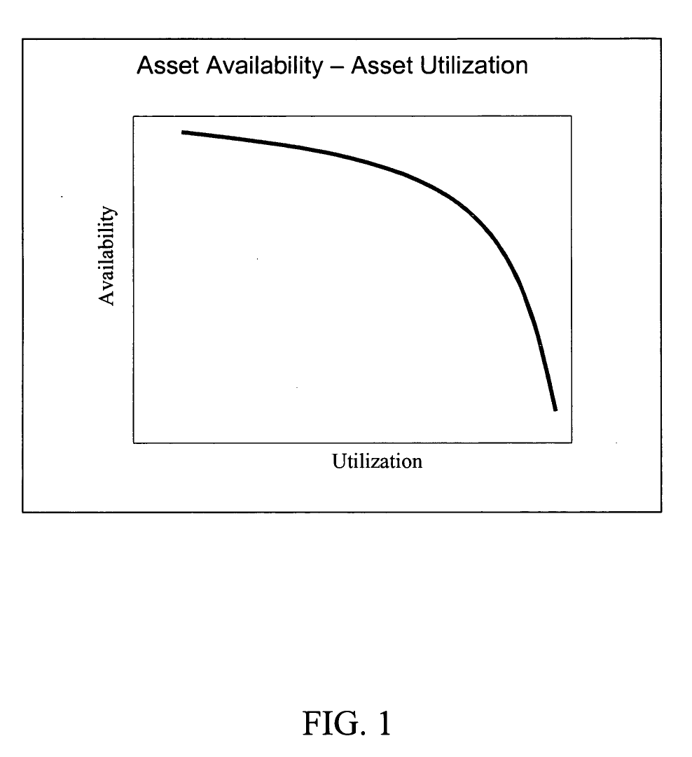

FIG. 2 shows an example of a decomposition of the assets of process plant into the base asset components of each asset;

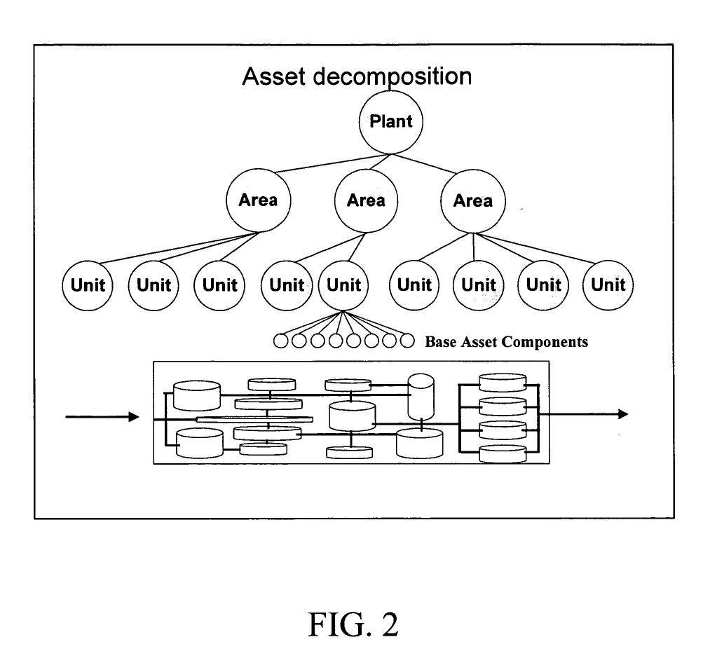

FIG. 3 shows a flowchart of a method of determining settings that produce optimal economic value from assets; and

FIG. 4 is a three-dimensional graph of economic value generated by different availabilities and utilization rates of assets, according to a relationship expressed in a model of the current invention.

### DETAILED DESCRIPTION OF AN ILLUSTRATIVE EMBODIMENT

To provide an overall understanding, certain illustrative embodiments will now be described; however, it will be understood by one of ordinary skill in the art that the systems and methods described herein may be adapted and modified to provide systems and methods for other suitable applications and that other additions and modifications may be made without departing from the scope of the systems and methods described herein.

Unless otherwise specified, the illustrated embodiments may be understood as providing exemplary features of varying detail of certain embodiments, and therefore, unless otherwise specified, features, components, modules, and/or aspects of the illustrations may be otherwise combined, separated, interchanged, and/or rearranged without departing from the disclosed systems or methods. Additionally, the shapes and sizes of components are also exemplary and unless otherwise specified, may be altered without affecting the scope of the disclosed and exemplary systems or methods of the present disclosure.

“Optimized” and/or “optimum,” and further, “maximum” and “minimum,” and derivatives thereof, as used-herein, may be understood to be within the context of which such terms are presented in the disclosed embodiments, e.g., with respect to the relationships presented and/or disclosed, as mathematically or other expressed, in relative terms, and/or as otherwise understood in the art.

“Operations” as used herein may be understood to include both the uses of an asset and the maintenance performed on an asset. When an operation is being performed on an asset or assets, the asset or assets is/are either being used or being maintained.

The methods and systems described herein utilize the availability of real-time economic performance measures of assets such as components in a process plant, and economic data generated thereby. Such real-time performance measures are described in, e.g., U.S. Pat. No. 5,134,574, which is incorporated by reference herein in its entirety. These real-time economic measures are directly calculated from operational performance data that are collected in real-time from sensors located, for example, at the plant floor in the plant automation systems of an industrial plant. This sensor-based information has been the domain of plant engineering, but provides a wealth of knowledge on what is going on in an industrial plant in real-time and to the process unit level and below, if necessary. To compute the economic value of the assets, certain economic information related to the collected operational data are needed. This economic information may come from a variety of sources, such as but not limited to accounting models that are constructed within the process control system. This makes the economic information in the plant available in real-time and to the plant equipment level. The economic value of an operations-related activity within a plant is thus discernable by calculating the value using the collected operational data and the economic information taken from the variety of sources.

The operational performance data and the economic performance data are both stored within a storage module, such as but not limited to a process historian, where the data are related by time. In most automated process manufacturing plants, operational performance data is collected in the process historian or a similar device. In a preferred embodiment, both the data storage and economic performance data calculations occur within a process control system. As the operational performance data are collected, each one is historized, or time-stamped. The same time-stamp is applied to the economic performance data calculated from that operational performance data. Over a period of time, a large database of time-related operational performance data and economic performance data is produced.

In addition to the operational performance data that is collected, the settings on the asset or assets that caused the operational data to result are also collected, time-stamped, and stored. These settings are determined by the operational personnel, which includes maintenance personnel as well as operators. Similar to operations performed on an asset or assets, the settings of an asset or assets are determined both when the asset or assets is/are being used, and when the asset/assets is/are being maintained.

The calculated real-time economic performance measures provide economic performance data for various parts of industrial plants, such as but not limited to plant units, plant sub units, plants areas, and entire plants. The real-time operational performance data and economic performance data may be used to drive the plant to optimal economic value in two ways.

The first way is to display the economic performance measures to plant operations, maintenance and engineering personnel in a simple manner. One manner of displaying this data is by placing it on a dashboard display in real-time. As the plant is operating, personnel are constantly changing the operating parameters, or settings, of those assets in the plant under their control. The personnel make these changes to produce better results and to deal with problems in the assets as they arise. For example, wear on an asset from use may cause the output of the asset to decrease. In trying to keep that output at a maximum value, personnel may change the parameters that control how the asset is operating to achieve maximum output given the change in the condition of the asset. As changes are made to the settings by the personnel, the collected operational performance data will also change. This causes corresponding changes in the economic performance data calculated from those changed operational performance data. As the changes in the economic performance data occur, they are shown, in real-time, on the display dashboard. This enables the plant personnel to determine, through the near-instantaneous feedback shown on the display, how the changes they make to the settings of an asset or assets impact the economic operation of the asset or assets within their domain of control.

Merely displaying the economic performance data in real-time may not lead to optimal economic value being produced from the plant assets. Over time, the economic value goals of the plant and its assets will change, just as the settings also change over time. For example, if the market price of the product being produced at the plant is currently very high, those with control over how the plant is operated may want to produce as much product as possible, regardless of the energy costs and material costs of so doing. In another example, high energy prices coupled with a decreased demand for the product may mean the primary economic goal is to lower energy costs while producing a lesser amount of product and keeping material costs low as well. Thus, to make optimal use of the real-time display of economic performance data, the data should be presented in a prioritized format, such that the current primary economic goal is displayed first, followed by the secondary goal, the tertiary goal, and so forth. Prioritization of the displayed economic performance data may be accomplished by contextualizing the finance data to the manufacturing strategy. This contextualization may be done by prioritizing the financial models for each unit of the plant, such as a process unit, according to the manufacturing strategy of the plant. To accomplish this, the manufacturing strategy, which is commonly developed for the plant as a whole, may be decomposed to the process area and process unit levels. This is accomplished through a process called a Vollmann Decomposition. This process identifies the metrics for each unit in prioritized order. These metrics are then displayed according to priority to the operators and maintenance personnel responsible for the appropriate plant sections.

Any number of economic performance measures may be displayed. In a preferred embodiment, the number of measures of economic performance data displayed is limited to up to four, as humans tend to have difficulty managing more than four metrics in real-time. One reason for this difficultly is that the metrics tend to fight each other. For example, the primary metric may be production with a secondary metric of energy cost. To increase production usually requires an increase in energy cost while the objective of the management of energy cost is to reduce it. Using the prioritized performance measures in this manner leads to a level of multi-objective open loop optimization that had not previously been attainable. This type of optimization is not as rigorous as mathematical optimizations, but it may be more flexible. In total, this approach will tend to move plant operations toward an economic optimum continuously over time, but provides no mechanism for a quantitative determination of the actual optimal point of operations and the settings of the assets that produce the optimal point.

The availability of real-time economic performance measures also leads to a number of new opportunities to determine how to use this new information to solve business problems whose solutions have been traditionally elusive. One such area of opportunity is the matching of plant economic data with plant operational data to be able to mathematically determine the correlation between operations and economics.

Thus, the second way to drive to optimal economic value by using real-time performance measures is to collect and historize the real-time economic performance data of the asset set as well as the real-time operational performance data of the asset set and the settings of the assets that result in that operational data, as described above. The operational data, settings, and economic data are then analyzed over a time period of interest. The process historian or similar device produces a database of time-sequenced operational performance data, settings, and economic performance data that may be time-resolved and analyzed. By applying linear and non-linear optimization methods to the time-correlated operational and economic performance data for a time period of interest, it is possible to determine optimal operating parameters in a very quantitative manner.

To properly analyze the operational and economic performance data, it is necessary to know how the economic performance of an asset, over time, relates to the availability and utilization of the asset over time. This relationship is expressed in various models described below, and has not previously been known. Knowing these models and relationships described therein enables clear tracking and understanding of how operational changes, reflected in the changes to the settings of assets, truly impact the prioritized economic variables in a process plant. Though these models are typically used to analyze historical data, they may be used to predict the economic impacts of operational changes to the settings of assets. This prediction may either be utilized to quantitatively determine the results of an action or to advise the operations staff on the impact of each of a number of scenarios, enabling the staff to determines those settings that result in optimal economical value for a set of circumstances. This prediction may be determined by using a quantitative method or methods to back-calculate the optimal availability and utilization combinations that result in optimal economic value generated by the asset set under analysis.

Rather than using component assets in an asset analysis model, an economic-operational model according to the current invention uses the overall asset value of more complex asset sets, such as but not limited to process units, process areas, or entire process plants. The availability of economic performance data at even the smallest level of an asset set, here the process unit level, enables the model of the current invention.

The model used in the current invention may be initially characterized as shown in Eq. 1:
Asset Performance=∫(Vₘₐₓ*AU*AA)dt (Eq. 1)
This model represents the base asset value and incorporates both asset utilization (AU) and asset availability (AA). Vₘₐₓ is the maximum value possible from the base asset component and dt is the amount of time over which the integral is taken. Both AU and AA are measured on a scale from 0.0 to 1.0. The model according to Eq. 1 relates asset availability and asset utilization to economic value. The relationship between utilization and availability is multiplicative, and utilization and availability are both fractional functions, which means the overall asset value declines significantly with small reductions in availability and utilization. Also, because utilization and availability are inverse functions at their maximum ranges, optimizing economic value from a simple asset component is a function of balancing both availability and utilization to an economic objective.

As described above, asset utilization ranges on a scale from 0.0 to 1.0, with 0.0 being no output and 1.0 being the maximum output of the asset set based on the current maintenance condition of the asset set. For example, a heat exchanger may have a maximum heat transfer at ideal conditions of 5 million BTU/hour. However, after running the heat exchanger for two months, it has scaled to the point at which the heat transfer has been reduced to 4.5 million BTU/hour; less than ideal conditions have occurred, as expected. If the operators are currently running the heat exchanger at 4 million BTU/hour, the asset availability would be 4.5/5.0=0.9, and the asset utilization in those conditions would be 4.0/4.5=0.89.

Vₘₐₓ may be stated as being equal to the maximum production value (PVₘₐₓ) minus the production cost at that production value rate (Cₘₐₓ). Thus, the component asset value model becomes:
Asset Performance=∫((PVₘₐₓ−Cₘₐₓ)*AU*AA)dt (Eq. 2)

The model according to Eq. 2 would be sufficient for accurately analyzing the value for a base asset component in an industrial operation. In theory, once the value of each component is modeled, they may be aggrandized to a larger asset set, a subunit, unit or event a whole process area. This may be done by mathematically combining the component assets into larger asset sets. However, such a recombination is not trivial. It involves effective application of systems, network and circuit theory, depending on the manner in which the component assets are combined. The complexity of accomplishing this makes this approach impractical. A close investigation of this bottom-up approach also reveals that determining the Vₘₐₓ function at the base asset component level is often meaningless because economic profit points do not occur at each component asset point in a process. In other words, PVₘₐₓ is not a base component asset concept. Trying to determine PVₘₐₓ at the base asset component level makes no sense.

By applying the concept of dynamic performance measures, which relate economic value to operational data collected in plants, it is possible to restate the model according to Eq. 3:
RP(DPMᵢ)=∫((PV_{max i}−C_{max i})*AUᵢ*AAᵢ)dt (Eq. 3)
where RP is the resource productivity of the asset set and DPMᵢ represents a vector of dynamic economic performance measures containing real-time economic performance data. The model according to Eq. 3 is derived from the base asset component models shown above in Eqs. 1 and 2. The model according to Eq. 3 may be used for any number of DPMs. When i is greater than 1, it is possible to use the model to produce a series of equations for each DPMᵢ or to combine those equations into a single equation of vectors for each i.

Though the model according to Eq. 3 is similar to the model according to Eq. 2 shown above, the model according to Eq. 3 takes on a very different connotation at the larger asset level because real-time economic performance data may be directly calculated at these higher levels. Thus, RP, resource productivity, may be seen as a multiple dimension vector because there typically are a number of economic performance measures at the larger asset set level, such as but not limited to energy cost, material cost, yield, production, and productivity. These economic performance measures, described is by DPMᵢ for i equal to a number greater than or equal to 1, in the equation are the real-time economic performance measures and data calculated over a period of time as described above. When RP is a vector, with the number of elements equal to the number of DPMs under analysis, PVₘₐₓ, Cₘₐₓ, AA, and AU must also be a vectors with an equivalent number of elements.

Solving for the right-hand-side of the model according to Eq. 3 may be possible. PVₘₐₓ and Cₘₐₓ are either known values or may be calculated from known values. Thus, they may be effectively dealt with as constant scalar values, although they may not be true constants across the full operating range of assets in a plant. Variations in each of PVₘₐₓ and Cₘₐₓ may be assigned to the AU and AA factors without a loss of accuracy. Treating PVₘₐₓ and Cₘₐₓ as described above, it may then be possible to solve for the elements of AA by using mathematical techniques, such as but not limited to Weibull functions. The elements of the AU vector may then be back-calculated. However, such computations are very complex. It is possible to use the relationships identified by the model according to Eq. 3 to analyze the collected operational performance data and the calculated economic performance data to determine an optimal balance between asset availability and asset utilization for each DPM without having to resort to calculating or measuring AA or AU.

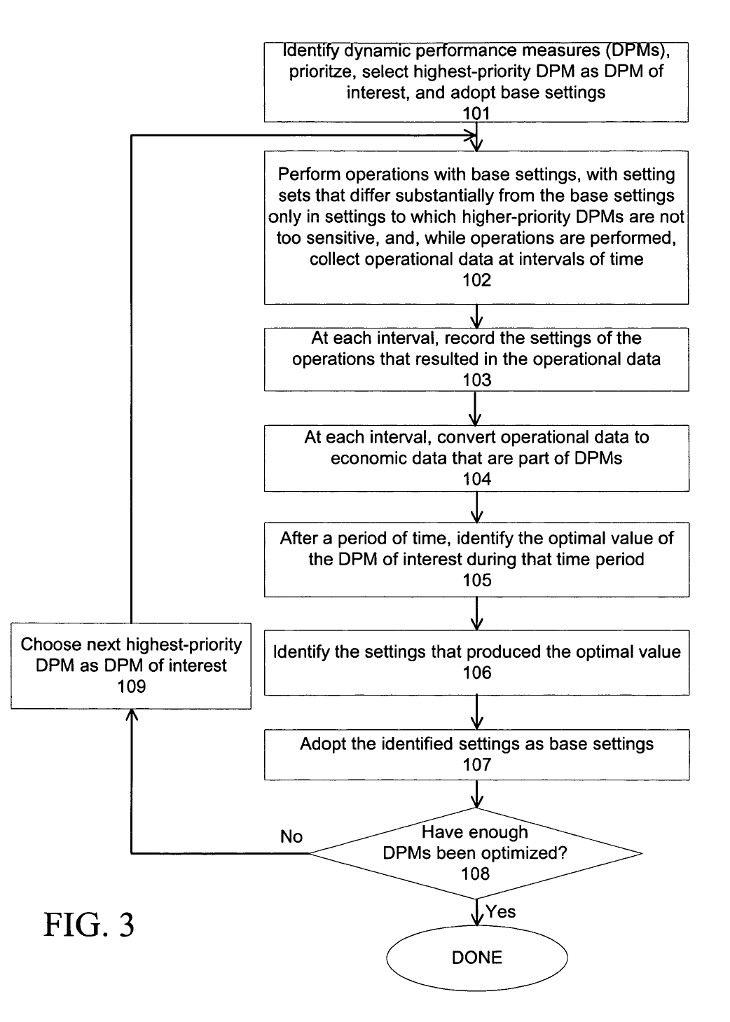

This analysis is performed for the assets of interest over a time period of interest. The steps of this analysis are shown in the flowchart of FIG. 3. For the time period of the interest, dynamic performance measures (DPMs) are identified and prioritized (step 101), as described above. The highest-priority DPM is selected as the DPM of interest, and base settings for the operations are adopted (step 101). Operations are then performed on the assets according to the base settings, with setting sets that differ substantially from the base settings only in settings to which higher-priority DPMs are not too sensitive (step 102). Now, since the sensitivities of the various DPMs to the settings may not all be known a priori, some settings to which higher-priority DPMs are sensitive may be changed temporarily, but for present purposes, those settings are not considered to be changed because they are changed back when that sensitivity is detected. While operations are being performed on the assets under analysis, operational performance data is collected for the assets at selected intervals of time (step 102). The settings on the asset or assets that resulted in the operational data are also recorded at the same intervals of time (step 103). The operational performance data will vary over time as changes are made to the settings, or operating parameters, of the assets, and as these assets are maintained. For each collected unit of operational performance data, a corresponding unit of economic performance data is calculated (step 104). One or more units of economic performance data may be grouped into a given economic performance measure, such as but not limited to production value, amount produced, energy costs, and so forth. (Each resultant economic performance measure is one of the DPMs of Eq. 3.) Each DPM thus varies over the time period of interest as the settings of the assets, and thus the operational performance data and the economic performance data, are changed. All of this data is placed in the process historian and related by time, resulting in a time-stamped database or table of the data.

After the time period of interest has passed, for the highest-priority DPM, the optimal value determined by that DPM during the time period of interest is identified (step 105). The optimal value may be a maximum value or a minimum value, depending on the DPM and the economic goals for the assets being analyzed. For example, if the DPM is energy cost and the economic goal is to minimize energy costs, the optimal value will be the minimum value of the DPM over the time period of interest. The time at which that optimal value occurred is then identified. For example, if the DPM is production value, the data may indicate that the optimal economic value occurred at day twenty-one, hour three, minute zero, second zero. The settings of the assets at the time that led to that optimal value for the DPM are then identified (step 106). In a subsequent period, these settings are, as steps 107 to 109 indicate, adopted as the base settings, and steps 102 to 107 are repeated if further DPM optimization is desired.

As the analysis is repeated in subsequent periods for respective DPMs of interest, some of the settings change. However, no significant changes are permitted in settings to which changes would adversely affect the value of one or more of the higher-priority DPMs. Such settings may often be identified a priori, by analyzing the system, while others become apparent as a result of trial and error. So, some of the settings determined from each iteration will remain unchanged over all successive iterations. For example, the settings produced from the second iteration will include a group of some settings unchanged from the results of the first iteration, and another group of settings that also may not be changed during successive iterations. This other group of settings includes those settings that, if changed, would impact the optimal value of the second-highest priority DPM. Thus, with each successive iteration, the number of settings that may be changed will decrease. This will result in a group of settings that should produce optimal values for each DPM of interest over time. Of course, this process may be implemented in a computer system, using hardware, software, or a combination of hardware and software.

The model according to Eq. 3 demonstrates that this iterative process should produce optimal asset availability and optimal asset utilization over time. As the values for each DPM on the left-hand side of the model according to Eq. 3 are optimized, by determining those settings that result in optimal DPM values, the availability and utilization of the assets that result from those settings should also be optimized.

Thus, the model according to Eq. 3 is a pragmatic model for dealing with the traditionally unsolvable problem of measuring and analyzing the economic value from an asset set in real-time when operations are being performed on the asset set. Though the models discussed herein are described with respect to the asset sets of industrial process plants, the model and analysis apply in the same way and produce the same results when used with any asset set. The keys are the relationships expressed by the model, that economic value is related to asset availability and asset utilization, and in that context, asset availability and asset utilization are multiplicative. Knowing this relationship enables anyone performing an analysis of the collected operational performance data and its corresponding calculated economic performance data to determine an appropriate balance between the availability of an asset and the utilization of the same asset over a period of time, as described above.

The mathematical models, the relationships expressed therein, and the analysis performed on the data indicate optimal operating practices in a very quantitative manner. The deficiency of this approach is that the models and analysis are based on historical information. Operating conditions frequently change over time, as industrial plants are very dynamic. Thus, the results may not truly represent the current operating conditions of the plant. However, in a well-maintained and operated facility the analysis from historical data should present a close approximation of current operations.

The use of the models presented herein with the availability of the real-time economic performance measures enables deriving increased measurable economic value from a set of assets. This may be achieved by using the two approaches described above in relation to industrial plants. The first approach is to prioritize the real-time economic performance measures according to a defined strategy. The prioritized measures are then presented in a dashboard format to those responsible for the use of the assets and the maintenance of the assets. Thus, those with the most second-by-second impact on the performance of the assets have immediate feedback on how the economic value of an asset changes as changes are made to the use and/or maintenance of the asset. Personnel may use this feedback to determine which actions and activities add value and which detract value from the asset. As the personnel learn from the feedback, they tend to continuously improve the economic value generated from the assets. They may never achieve a mathematical optimum, or at least they may never be sure they have, but they will experientially drive asset performance in the desired directions.

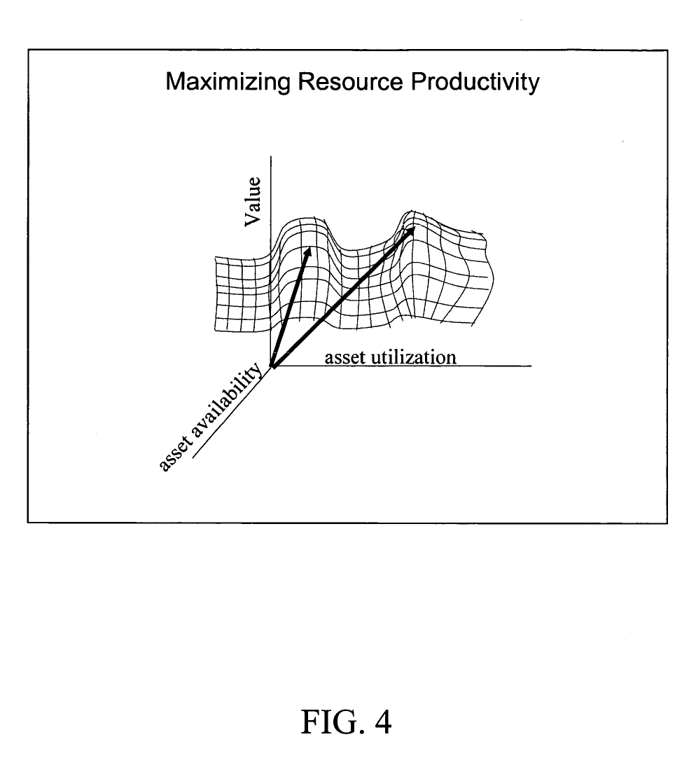

To achieve a mathematical optimum requires a more rigorous and quantitative approach. In this second approach, as described above, historical data is used to determine those settings that result in optimal economic values being produced, either through the iterative process described above or by calculation as described above. The results demonstrate the relationships between economic value and the operational metrics for asset availability and asset utilization as they have occurred in the past. Assuming these relationships will be somewhat consistent over time, they may be used to help predict those operations that result in optimal economic value for each asset. An example graph that relates economic value with the availability and utilization of an asset is shown in FIG. 4. The limitation of this approach is that the economic data is based on historical operational data that may or may not accurately represent the current operating conditions for the asset set. As the operating conditions of the asset set change over time, this approach may not produce the exact operations for optimum economic value.

The two approaches, (i) real-time performance feedback and (ii) quantitative optimization of economic and operations performance data, when applied separately, have different strengths and weaknesses. The first approach has the strength of providing current data that reflects the actual current operating conditions of the asset set. A weakness of the first approach is that the real-time feedback data is likely being used on a “trial and error” basis to try to drive maximum economic value from the assets, without ever knowing whether an actual maximum has been achieved. The second approach has the strength of mathematically driving to an optimum. However, the weakness of the second approach is that the optimum is based on historical data and may not reflect the actual current operating conditions of the asset set. Thus, the strengths and weaknesses of the two approaches complement each other.

To achieve dynamic optimization of the economic output from an asset set, the two approaches are combined into a unified, multidimensional optimization methodology. The second approach may be used to determine the initial settings for the assets that result in the optimal economic output of the plant. These initial settings may then be dynamically adjusted by using the operational performance feedback methodology of the first approach. The second approach may then be reapplied periodically to ensure that the operators have not drifted from the actual optimal point of operations. Using the two approaches together overcomes the weaknesses of each and builds on the strengths each has to offer, resulting in nearly optimal operation of assets in an asset set.

It is also possible to determine the overall economic value generated (EVG) over baseline operations for a period of time, after the initial settings for the assets have been determined and at least one change has been made to the operating conditions. Using the model according to Eq. 3, the overall economic value generated may be calculated by integrating, over a period of time, the difference between the dynamic resource productivity vector (RP₁), determined from economic data calculated after the change was made, and the baseline resource productivity vector (RP₀) that is calculated by the historian. Finally, the vector components (DPMₓ) are summed, as shown according to Eq. 4 below:

$$EVG = {\int }_{{t}_{0}}^{{t}_{1}} {RP}_{1} ( {DPM}_{1} , {DPM}_{2} , {DPM}_{3} … ) - {RP}_{0} ( {DPM}_{1} , {DPM}_{2} , {DPM}_{3} … ) ⅆ t \qquad ( Eq . 4 )$$

The calculation of overall economic value generated over baseline operations for a period of time may be very useful in assessing the economic return of an improvement activity or a set of improvement activities as defined by changes in the settings of the assets. Although the concept of economic return on investment is commonly discussed in industrial operations, it is seldom directly calculated. The model shown in Eq. 4 provides a mechanism for the direct calculation of economic return on investment. This calculation may also be utilized to normalize the positive or negative effects of subsequent actions or activities from the activity under analysis.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single or multiple processor/devices.

The device(s) or computer systems that integrate with the processor(s) may include, for example, a personal computer(s), workstation (e.g., Sun, HP), personal digital assistant (PDA), handheld device such as cellular telephone, laptop, handheld, or another device capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus may be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or is a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the interent References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art. Accordingly, it will be understood that the disclosed methods and systems are not to be limited to the embodiments disclosed herein, may include practices otherwise than specifically described, and are to be interpreted as broadly as allowed under the law.

1. A method of determining, for a set of assets on which operations are performed, settings for the operations that result in the assets producing optimal economic value, where operations include use of the assets and maintenance performed on the assets, and the settings and operations change over time, the method comprising:
prioritizing dynamic performance measures, where dynamic performance measures comprise economic performance data;
performing, during a time period, a process that includes:
collecting and storing, as operations are performed on the assets, operational performance data about the assets and the settings that produced the data;
calculating and storing, in real-time, economic performance data from the collected operational data; and
determining, for the highest-priority dynamic performance measure, those settings that will result in optimal economic value from the assets for that measure, by identifying the optimal value for the measure over a period of time and identifying the set of settings that produced the optimal value during that period of time; and
determining, for each of a plurality of successive dynamic performance measures in order of decreasing priority, the settings that will result in optimal economic value from the assets for each measure, by repeating the above process with sets of settings that do not result in a substantial change in the value of any higher-priority measure from its identified optimal value.

2. The method according to claim 1, further comprising:
setting initial settings for the operations, where the initial settings are the settings determined according to the process, and the process has been repeated for the plurality of successive measures;
displaying at least one of the dynamic performance measures in real-time; and
determining if changes made to the initial settings result in further optimal economic value being derived from the assets, by:
changing at least one of the initial settings;
viewing the displayed measure over time to learn if the at least one changed setting has positively impact the measure; and
if there is a positive impact on the measure, maintaining the at least one changed setting, and if not, returning the at least one changed setting to its initial setting.

3. The method according to claim 2, further comprising:
repeating the process for the highest-priority dynamic performance measure and the plurality of successive measures to determine further settings;
comparing the further settings to the current settings to determine any differences between the current settings and the further settings; and
changing the current settings to the further settings if there are differences.

4. The method according to claim 1, wherein storing occurs in a process historian.

5. The method according to claim 4, wherein the process historian is part of a process control system, and collecting and calculating occur within the process control system.

6. A computer system configured to determine, for a set of assets on which operations are performed, settings for the operations that result in the assets producing optimal economic value, where operations include use of the assets and maintenance performed on the assets, and the settings and operations change over time, the computer system configured to:
prioritize dynamic performance measures, where dynamic performance measures comprise economic performance data;
perform, during a time period, a process that includes:
collecting and storing, as operations are performed on the assets, operational performance data about the assets and the settings that produced the data;
calculating and storing, in real-time, economic performance data from the collected operational data; and
determining, for the highest-priority dynamic performance measure, those settings that will result in optimal economic value from the assets for that measure, by identifying the optimal value for the measure over a period of time and identifying the set of settings that produced the optimal value during that period of time; and
determine, for each of a plurality of successive dynamic performance measures in order of decreasing priority, the settings that will result in optimal economic value from the assets for each measure, by repeating the above process with sets of settings that do not result in a substantial change in the value of any higher-priority measure from its identified optimal value.

7. The computer system according to claim 6, further configured to:
set initial settings for the operations, where the initial settings are the settings determined according to the process, and the process has been repeated for the plurality of successive measures;
display at least one of the dynamic performance measures in real-time; and
determine if changes made to the initial settings result in further optimal economic value being derived from the assets, by:
changing at least one of the initial settings;
viewing the displayed measure over time to learn if the at least one changed setting has positively impact the measure; and
if there is a positive impact on the measure, maintaining the at least one changed setting, and if not, returning the at least one changed setting to its initial setting.

8. The computer system according to claim 7, further configured to:
repeat the process for the highest-priority dynamic performance measure and the plurality of successive measures to determine further settings;
compare the further settings to the current settings to determine any differences between the current settings and the further settings; and
change the current settings to the further settings if there are differences.

9. The computer system according to claim 6, wherein the computer system is a process control system.

10. A method of calculating economic value generated from the operations performed on a set of assets over a period of time as those operations change, the method comprising:
collecting and storing, in real-time, operational performance data about the assets in the set as operations are performed on the assets;
calculating and storing, in real-time, economic performance data from the collected operational performance data, where the economic performance data comprise dynamic performance measures;
determining a baseline value for each dynamic performance measure over the period of time; and
determining, for each measure, the difference between the current value of the measure and the baseline value of the measure.

11. The method according to claim 10, wherein storing occurs in a process historian.

12. The method according to claim 11, wherein the process historian determines the baseline value for each dynamic performance measure over the period of time.

13. The method according to claim 12, wherein the process historian is part of a process control system, and collecting, calculating, and determining the difference all occur within the process control system.
